(19) United States
(12) Patent Application Publication
(10) Pub. No.: US 2008/0292238 A1
(43) Pub. Date: Nov. 27, 2008

(54) Temperature-Resistant Ir Measurement Probe

(76) Inventor: Lukas Kupper, Aachen (DE)

Correspondence Address: BROOKS KUSHMAN P.C., 1000 TOWN CENTER, TWENTY-SECOND FLOOR, SOUTHFIELD, MI, 48075, US

(21) Appl. No.: 12/092,201

(22) PCT Filed: Oct. 27, 2006
(86) PCT No.: PCT/DE06/01896

§ 371 Date: Apr. 30, 2008

(30) Foreign Application Priority Data
Oct. 30, 2005 (DE) 10 2005 052 223.8

(51) Int. Cl. G02B 6/10

(52) U.S. Cl. 385/12

(57) ABSTRACT

A temperature-resistant fibre-optic-coupled IR measurement probe and an FTIR measurement system with a connected temperature-resistant fibre-optic-coupled IR measurement probe are presented. The temperature stability is achieved by mounting the optical fibre sections (13, 14) in the temperature-controlled probe head housing (12) without any fastening points. The optical fibres are manufactured using a restoring force which acts along the optical fibre axes (22,23) in the direction of the probe element. In the event of a change in temperature, the optical fibres expand in the probe head housing. The probe head housing should be dimensioned in such a manner that, on the one hand, expansion of the optical fibres without damage is ensured and, on the other hand, the optical fibre ends (15,16) are mounted in front of the probe element (11) using a restoring force. This is achieved, for example, by means of plastic bending of the optical fibres in the probe head housing, wherein the optical fibres are firmly connected to the probe head housing in the section between plastic bending and flexible optical fibre section.

The invention relates to a waveguide-coupled measurement probe which uses the principle of attenuated total internal reflection (ATR) and to a measurement system with waveguide-coupled ATR measurement probe for process monitoring by means of infrared spectroscopy.

While spectroscopy in near infrared and visible spectral ranges has been used routinely for many years in analytical laboratories, in particular of the chemical industry, to track reactions, the current prior art in the mid-infrared spectral range only allows process monitoring within the laboratory framework.

Various measurement techniques currently used there exist.

In particular diamond ATR measurement technology has evolved to a chemically and mechanically extremely robust measurement method. Immersion probes, comprised of robust diamond ATR measurement heads and hollow-waveguide beam transfer optical systems or waveguide optical systems, for online process control have also been commercially available for a few years. These probes are used to track events during the reaction in a manner which is substantially more selective and more detection-sensitive than by way of near infrared probe technology.

The major disadvantage of the hollow-waveguide-based MIR immersion probes, however, is their rigid voluminous design and their extremely strong adjustment sensitivity.

Waveguide-coupled immersion probes which, although they are flexible and adjustment friendly, are at the same time very temperature-sensitive on account of the optical waveguides used, are also available.

U.S. Pat. No. 5,923,808 describes a temperature-resistant, waveguide-coupled ATR immersion probe which is kept at a constant temperature level by way of active cooling. Cooling is effected by way of nitrogen purging. Additionally, temperature decoupling is effected between probe elements and optical waveguides by way of an infrared-transparent optical element which is stable in the corresponding temperature range. The optical waveguides used are based on chalcogenide compounds.

DE10123254 describes an infrared measuring probe comprised of an ATR diamond element and a silver-halide waveguide system. The infrared radiation exiting the optical waveguide is coupled into the probe element via a microoptical system.

U.S. Pat. No. 5,185,834 shows an ATR measuring probe for the infrared spectroscopy with a probe body for two internal reflections. The probe body is preferably comprised of ZnSe and a lens is formed on its one side. The beam-supplying and beam-detecting optical waveguide is fixed in an adjustable holder at a constant distance to the probe body.

U.S. Pat. No. 5,585,634 discloses a fibre-optic infrared measuring probe with an optical waveguide section as ATR probe element. The optical waveguide section is embedded in epoxy resin and a plane part of the optical waveguide section acts as sensitive sensor surface.

Moreover, the prior art describes hollow-waveguide-based immersion probes (e.g. by the companies Axiom and Mettler-Toledo) which can be employed in the temperature range from −100° C. to 300° C. In these probes, the infrared radiation is guided via mirror optical systems to the probe element and from there to the detector. In the region of the probe head, only materials which exhibit nearly identical expansion coefficients in the desired temperature range are used. Alternatively, the components to be connected are joined together via sealing ring systems.

All the waveguide-coupled infrared measuring probes described in the prior art have some disadvantages. IR measuring probes, comprised of rigid mirror arm systems, may be temperature-stable, but are not flexible, adjustment sensitive and have only a very short range.

IR measurement probes on the basis of optical waveguides, on the other hand, are flexible, compact and have a significantly larger range. The IR measurement probes described in the prior art can, however, be used without active cooling only over a very narrow temperature range.

They generally comprise a probe element, an illumination waveguide and a detection waveguide, which are both either fixedly connected to the probe element or are fixed to the probe head housing upstream of the probe element. Due to the extremely different expansion coefficients between probe element, surrounding probe head housing and optical waveguide, fixing the optical waveguides to the probe head housing or to the probe element, as described in the above inventions, for applications which do not take place in a narrow temperature range is suitable only if the probe head is actively cooled. Adjusting a defined temperature in the region of the measurement head is very complex on account of active cooling and may in some circumstances falsify the measurement result.

Polycrystalline silver halide compounds, such as AgCl—AgBr have, for example, have an expansion coefficient of typically 35*10̂−6, whereas SiO₂-based glass waveguides, for example, which are used in the near infrared spectral range, have an expansion coefficient which is smaller by about 2 orders of magnitude. Measurement probes based on glass waveguides therefore require a completely different packaging technology as compared to optical waveguides made of polycrystalline silver halide material. Commercially available glass waveguide probes, which are used in the temperature range up to 180° C., can be fixed permanently and consistently upstream of the probe element for example using high-temperature adhesives on epoxy resin basis. Silver halides are, as compared to other infrared transparent materials used as optical waveguide materials, such as chalcogenide glass waveguides, also permanently temperature-resistant from −150° C. to 250° C. and are therefore suitable, with the right packaging, for use in this temperature range.

It is the object of the invention to specify an IR measurement probe and a measurement system with an IR measurement probe, which can be used over a wide temperature range and still has the advantages of a waveguide optical system, such as flexibility, compactness, simple operability and multiplexibility.

This object is achieved by way of claim 1 and a measurement system as claimed in claim 10. Dependent claims relate to advantageous embodiments of the invention.

The invention provides that the illumination and detection waveguide end, which faces the probe element, is mounted such that it can extend or shorten elastically with the heating and cooling of the probe head housing, i.e. without plastic deformation. This is achieved, for example, by the probe head housing enclosing a volume which allows the destruction-free extension of the optical waveguides for example by elastic displacement of the optical waveguides in the lateral direction. Plastic deformation of the optical waveguides leads to a degradation of the transmission characteristics of the optical waveguides and can be avoided by a sufficiently large dimensioning of the evasion volume.

Furthermore, the optical waveguides are kept, over a wide temperature range, at a defined lateral and axial distance from the probe element. Reproducible measurement results are possible only if the position of the waveguide ends relative to the probe element does not change during the tracking of a laboratory reaction. This is realized via a restoring force which acts along the optical waveguide axis.

As the probe element, attenuated total reflection (ATR) elements, transmission and reflection elements are advantageous. In particular ATR elements must be used regularly under increased probe head temperature conditions. Active cooling not only cools the temperature-sensitive optical waveguides, but also the probe element and thus the measurement environment. Since ATR measurements take place only in a layer, which is a few micrometers thick, around the ATR element, these measurements would yield incorrect results in the case of active cooling. ATR measurements at a raised or reduced temperature therefore only make sense without active cooling. The IR measurement probe according to the invention yields non-falsified measurement data without active cooling in the temperature range from −150° C. to 250° C.

In a preferred embodiment, polycrystalline silver halide waveguides with a core/jacket structure are used. These optical waveguides are sufficiently flexible and can be used permanently in the temperature range from −150° C. to 250° C.

Optical waveguides with a rectangular cross section are particularly advantageous since they can be matched better to the cross sectional area of the probe element and can additionally make contact with one another and be fastened in an areal manner. Areal fastening improves the reproducibility of the measurement data.

Optical waveguides with a pure core structure, so-called core waveguides, have a higher numerical aperture and thus a radiation throughput which is higher in principle than core/jacket waveguides. In particular where IR measurement probes with short, rigid or nearly rigid structure are required, core waveguides yield significantly better measurement results with respect to the signal to nose ratios in the spectral range with from 2 μm to 8 μm wavelength.

The use of single-crystalline optical waveguide sections, at least in the temperature-controlled region of the probe head, allows the use of the IR measurement probe in the temperature range up to 350° C.

The two optical waveguide ends are preferably connected to the probe element without optical gap. This ensures maximum radiation throughput since no Fresnel radiation losses occur. The gap-free coupling can be realized by way of a layer whose refractive index lies between the refractive index of the probe element and of the optical waveguides.

An alternative coupling option between optical waveguides and probe element does not provide for any fixing in the region of the probe element. This variant has the advantage that the optical waveguide can be interchanged very easily. This is advantageous if, for example, the probe is intended to be used for applications in different spectral ranges.

If illumination and detection waveguides are connected to one another upstream of the probe element, but not to the probe head housing, this improves the reproducibility of the radiation coupling between optical waveguides and probe elements since no relative offset between both optical waveguides can occur.

Detection and illumination waveguides are mounted in a defined position upstream of the probe element by way of a restoring force. In order that this restoring force can act, the optical waveguides must be fastened at a location of the probe head housing which lies outside the expansion region and downstream of the element producing the restoring force.

In another advantageous embodiment, the illumination and/or detection waveguides are connected on their entire length only at one point between couple-in or couple-out end and probe element to the surrounding sleeve, wherein the surrounding sleeve can be the probe head housing, the flexible optical waveguide protective sleeves or the optical waveguide connectors. In particular for IR measurement probes with very short optical waveguide sections, which are for example hardly moved during use or not moved at all, with a length of less than 1 m, fastening to more than one point is disadvantageous.

Preferably, the restoring force is produced by elastic bending of the illumination and detection waveguide in the rigid probe head housing. To this end, the probe head housing must be designed such that sufficient room is available for a further elastic deformation of the optical waveguides, as a consequence of the temperature expansion, up to a maximally possible temperature.

If the available probe body volume must be kept very small, the realization of the restoring force by way of a moderate plastic bending is advantageous. Moderate bending comprises radii of curvature of more than 30 mm. Very small probe bodies are advantageous for example if IR measurement probes with rigid beam transfer optical systems must be used. Such IR measurement probes are packaged preferably in a continuously rigid housing.

The realization of the spring force by way of an axially acting elastic spring force is advantageous if the probe body has a very slim elongate, for example cylindrical, shape, in particular in the case of a length to diameter ratio of the probe body of more than 25. If the optical waveguide is guided downstream of the elongate probe body in a flexible protective tube with a length of at least 0.3 m and an internal diameter of more than or equal to twice the optical waveguide diameter, no expansion volume which exceeds the external diameter of the slim probe body needs to be provided. Such IR measurement probes can preferably also be packaged in a continuous rigid pipe.

In particular in chemical and biotechnological applications, reaction temperatures in the range from −150° C. to 250° C. are possible. The IR measurement probes used not only need to be resistant in this temperature range, but must furthermore yield reproducible measurement data. In this temperature range, the length of silver halide waveguides (expansion coefficient: 40*10̂−6) changes to a length of 20 cm in the range of about 3.5 mm, i.e. the expansion volume in the probe body must be designed accordingly.

A temperature stability of more than 250° C. can be achieved if the optical waveguides can be packaged in a vacuum-tight and gas-tight manner in the region of the probe head.

The signal to noise ratio of the IR measurement probe can be significantly improved if the IR radiation is coupled into the probe element or out of it via a microlens which is formed on the optical waveguide end of the couple-in and/or detection waveguide. A particularly high radiation throughput is achieved if at least the couple-in waveguide end is provided with a lens whose focal length is more than 0.3 times the optical beam path between input and detection waveguide end.

As compared to IR measurement probes from the prior art, the IR measurement probe according to the invention can be connected to any desired FTIR spectrometers, dispersive IR spectrometers, IR filter spectrometers or else IR laser light sources very easily with the aid of conventional IR optical systems. The high radiation throughput and the optical characteristics, such a numerical aperture and optical waveguide diameter, of the optical waveguides need no special adaptations in terms of apparatus.

The IR measurement probe according to the invention can be connected to an IR detector element or to a laser light source or filtered light source without additional coupling optical systems. This significantly improves the radiation throughput. Additionally, at least one optical component can be omitted, which, in addition to the costs, also reduces the adjustment complexity.

Highly sensitive IR detector elements are cooled to liquid nitrogen temperature. A direct coupling of the detection waveguide experiences particularly little loss if the detection waveguide has an expansion volume upstream of the detector element.

Below, two embodiments of the invention will be described in more detail using drawings, in which

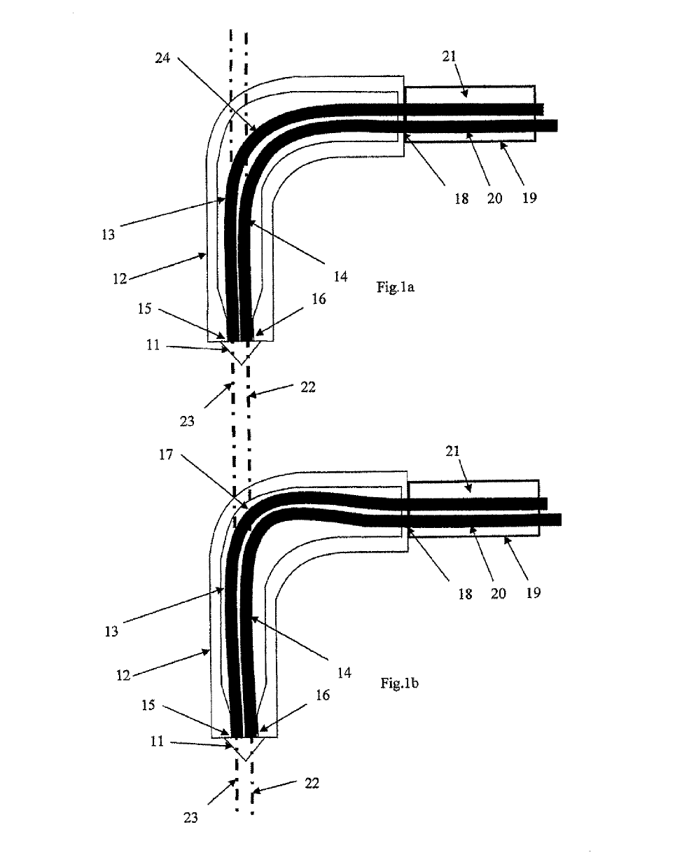

FIG. 1 shows a cross section through the probe head housing (12) of the inventive IR measurement probe, wherein FIG. 1a shows the path of the optical waveguides at room temperature and FIG. 1b at 250° C. The optical waveguides used are silver halide waveguides with a core diameter of 0.9 mm and a jacket diameter of 1 mm. Illumination (13) and detection (14) waveguides are located in the probe head housing (12), at one end of which the probe element (11), a 90° diamond ATR prism with rectangular cross-sectional area, is enclosed. Illumination (13) and detection (14) waveguides are adhesively bonded in a plastic bend (24) with a radius of curvature of 40 mm and with low prestressing at the optical waveguide exit (18) of the probe head housing (12) at room temperature (T=20° C.). The prestressing must be chosen to be sufficiently high so that the end faces (15 and 16) of the illumination (13) and detection (14) waveguides are still pressed onto the diamond prism (11) at −150° C.

Illumination (20) and detection (21) waveguides extend in a flexible protective tube (19) downstream of the probe head housing (12).

With an increase in the temperature in the region of the probe element (T=250° C.), illumination (13) and detection (14) waveguides expand by about 2.5 mm and spread into the expansion volume (17) of the probe head housing. At the same time, the front faces (15 and 16) are held in the position upstream of the probe element due to the restoring force which acts along the optical waveguide axes.

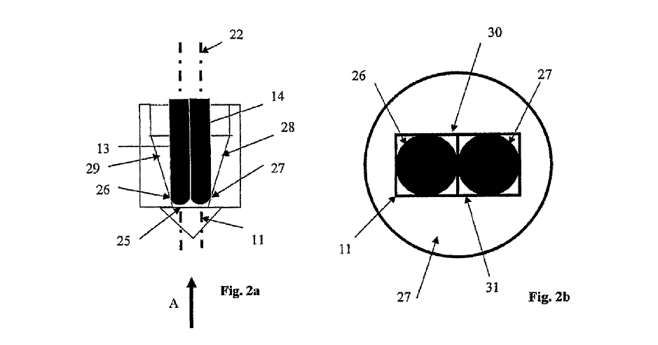

FIG. 2 shows a preferred embodiment of the optical waveguide faces (26 and 27) and the positioning aid faces (28) upstream of the probe element (11). Using a lens on the illumination waveguide end (26), the IR radiation is coupled into the probe element in a focussed manner and collected using a lens on the detection waveguide end (27). The couple-in lens (26) focuses the radiation approximately into the center of the diamond prism so that the entire radiation is transferred into the detection waveguide. The lens on the detection waveguide transforms the impinging radiation into low-mode radiation which can then be transmitted very efficiently in the detection waveguide.

The four cone-shaped positioning aid faces (28) ensure that the illumination and the detection waveguide ends are mounted in a self-adjusting manner and also have a defined position in the place perpendicular to the optical waveguide axis (22) and, in the case of vibration or other mechanical agitation, cannot spread laterally.

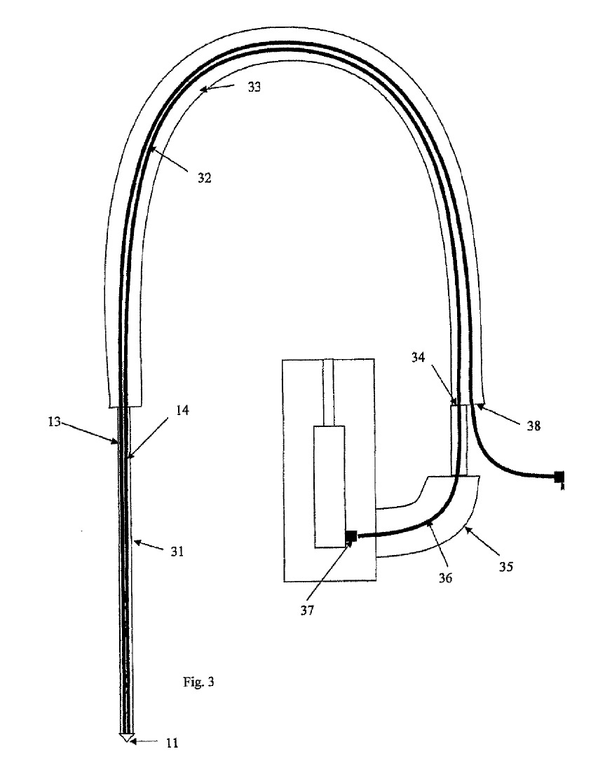

FIG. 3 shows a further preferred embodiment of the IR measurement probe. Illumination (13) and detection (14) waveguides are adhesively bonded in an elastic bend (32) with a radius of curvature of 100 mm at the end of the part (33), which is bent in the shape of a semicircle, of the probe head housing (38) at room temperature (T=20° C.). When heating the unbent part of the probe head housing (31), the optical waveguides elastically expand into the bent part of the probe head housing.

The internal diameter of the bent part is 3 mm and its length is 50 cm. It comprises a plastically deformable pipe section which can be deformed in each radius of curvature between 100 mm (the shape of a semicircle) and infinity (straight), i.e. the straight section of the probe head housing can assume any position between perpendicular upwards, horizontal and perpendicular downwards. The external diameter of the straight probe body section (33) is 3 mm and its length is 200 mm. Downstream of the adhesively bonded in and elastically bent detection waveguide section, the detection waveguide end (36) is coupled to an IR detector element (37), which is cooled using liquid nitrogen, in a plastic bend above a 90° pipe flange (35). The couple-in waveguide has, downstream of the adhesion location (38), a flexible length of 1 m before it issues in a fiber connector which can be used to connect the IR measurement probe to an IR light source or an IR spectrometer.

FIG. 1a shows a sectional view through a probe head of the IR measurement probe according to the invention at room temperature,

FIG. 1b shows a sectional view through a probe head of the IR measurement probe according to the invention at a maximum temperature of 250° C.,

FIG. 2a shows a detailed sectional view through a preferred embodiment of the probe head tip,

FIG. 2b shows a view of the probe head tip from direction A, and

FIG. 3 shows a sectional view through an IR measurement probe according to the invention with fixedly connected IR detector which is cooled using nitrogen.

1. A waveguide IR measurement probe for IR spectroscopy comprising an illumination waveguide, a detection waveguide and a probe element, which is enclosed at one end of a probe head housing, wherein the illumination waveguide and the detection waveguide extend between the probe head housing and an IR spectrometer in a flexible optical waveguide section and the optical waveguides in the probe head housing have, in a broad temperature range independently of the temperature of the probe head housing, a defined position relative to the probe element, which position is realized by virtue of a restoring force which acts along the optical waveguide axis, characterized in that the illumination and/or the detection waveguide between the probe element and the flexible optical waveguide section has at least one bend which produces the restoring force, wherein the illumination and detection waveguide sections, which face the probe element, are mounted such that, as the probe head housing heats and cools, they can lengthen and shorten elastically, i.e. without plastic deformation, for which purpose the probe head housing surrounds a volume which allows the destruction-free extension of the optical waveguides by elastic displacement of the optical waveguides in the lateral direction.

2. The waveguide IR measurement probe as claimed in claim 1, characterized in that the bend is an elastic bend.

3. The waveguide IR measurement probe as claimed in claim 1, characterized in that the bend is a plastic bend.

4. The waveguide IR measurement probe as claimed in claim 2, characterized in that the plastic bend has a radius of curvature of more than 30 mm.

5. The waveguide IR measurement probe as claimed in claim 1, characterized in that it has an illumination waveguide bundle and/or a detection waveguide bundle which extends between the probe head housing and the IR spectrometer in a flexible optical waveguide section.

6. The waveguide measurement probe as claimed in claim 1, characterized in that the probe element is an ATR element, a transmission or reflection cell.

7. The waveguide measurement probe as claimed in claim 1, characterized in that the illumination and the detection waveguides are composed of a silver halide compound with core/jacket structure.

8. The waveguide measurement probe as claimed in claim 1, characterized in that the illumination and/or the detection waveguide has a rectangular cross section.

9. The waveguide measurement probe as claimed in claim 1, characterized in that the illumination and/or the detection waveguide has no solid jacket.

10. The waveguide measurement probe as claimed in claim 1, characterized in that at least the illumination and/or the detection waveguide section in the temperature-controlled region of the probe head is composed of single-crystalline silver halide material.

11. The waveguide measurement probe as claimed in claim 1, characterized in that the illumination and detection waveguides are not fastened upstream of the probe element.

12. The waveguide measurement probe as claimed in claim 1, characterized in that the illumination and/or the detection waveguide end is connected to the probe element without any gaps.

13. The waveguide measurement probe as claimed in claim 1, characterized in that the illumination and detection waveguides are fixedly connected to one another.

14. The waveguide measurement probe as claimed in claim 1, characterized in that the illumination and detection waveguides are fixedly connected to the probe head housing and/or the flexible waveguide jacket at the transition location of the probe head housing to the flexible optical waveguide sections.

15. The waveguide measurement probe as claimed in claim 1, characterized in that the illumination and the detection waveguides are connected to the surrounding sleeve only at one point between couple-in or couple-out end and probe element.

16. The waveguide measurement probe as claimed in claim 1, characterized in that a defined distance between the illumination and detection waveguides and the probe element is adjusted via an elastic restoring force which acts along the optical waveguide axes.

17. The waveguide measurement probe as claimed in claim 1, characterized in that the illumination and detection waveguides in the probe head housing are mounted such that they can lengthen or shorten without any plastic deformation by up to 4 mm.

18. The waveguide measurement probe as claimed in claim 1, characterized in that the illumination and detection waveguides in the probe head housing are mounted in a vacuum or an inert gas atmosphere.

19. The waveguide measurement probe as claimed in claim 1, characterized in that a microlens is formed on the illumination and/or the detection waveguide end upstream of the probe element.

20. A measurement system comprising an IR spectrometer with waveguide coupling optical system and an optical waveguide measurement probe which is designed as claimed in claim 1.
